(19) United States
(12) Patent Application Publication
(10) Pub. No.: US 2024/0318482 A1
(43) Pub. Date: Sep. 26, 2024

(54) FITTING FOR MOVABLY MOUNTING A PIVOTING ELEMENT

(71) Applicant: Julius Blum GmbH, Hoechst (AT)

(72) Inventor: Thomas Schuler, Hard (AT)

(21) Appl. No.: 18/673,654

(22) Filed: May 24, 2024

Related U.S. Application Data
(63) Continuation of application No. PCT/AT2022/060410, filed on Nov. 22, 2022.

(30) Foreign Application Priority Data
Nov. 26, 2021 (AT) A 50947/2021

(51) Int. Cl. E05D 7/12; E05F 5/00

(52) U.S. Cl. CPC E05D 7/123; E05F 5/006; E05Y 2900/20

(57) ABSTRACT

A fitting for movably mounting a pivoting element of a door or a window relative to a stationary support, includes a first substantially cuboid-shaped fitting part to be arrangeable substantially completely in a recess on an end face of a panel of the support, and a second fitting part for securing to the pivoting element, the second fitting part being pivotally connected to the first fitting part. The second fitting part can be arranged substantially completely in the pivoting element. A damping device damps a pivoting movement of the two fitting parts relative to each other. The damping device can be converted from a first damping position into a second damping position with a reduced damping performance relative to the first damping position, and the damping device is arranged in the first fitting part. A securing device is provided for holding the damping device in the second damping position.

### BACKGROUND OF THE INVENTION

The invention relates to a fitting for movably mounting a pivoting element, in particular a furniture part, a door or a window, relative to a stationary support.

Such fittings are already known from the state of the art, for example from the applicant's own AT 506 903. The disadvantage is that a relatively complicated mechanism is needed in order to be able to transfer a damping device from a first damping position into a second damping position with a reduced damping performance relative to the first damping position. For one thing, this is associated with a higher production effort and higher production costs. For another, a complex mechanism is also more prone to defects.

Moreover, the development of using fittings which as far as possible are not visible or only slightly visible to a user in the installed state is becoming increasingly apparent. This is achieved for example in that the fitting parts of a fitting are arranged as far as possible completely in the stationary element or in the pivoting element. The design of such fittings means that it is not possible to use a device according to the state of the art to transfer a damping device from a first damping position into a second damping position with a reduced damping performance relative to the first damping position.

### SUMMARY OF THE INVENTION

The object of the present invention is to at least partially avoid the described disadvantages according to the state of the art, and to specify a fitting, improved compared with the state of the art, for movably mounting a pivoting element, in particular a furniture part, a door or a window, relative to a stationary support, as well as a piece of furniture with such a fitting.

Thus, it is accordingly provided that the damping device can be transferred from a first damping position into a second damping position with a reduced damping performance relative to the first damping position. The damping device is arranged in the first fitting part, and a securing device is provided for holding the damping device in the second damping position.

According to a preferred embodiment, the damping device has an engagement element and the securing device has a securing element, and the securing element can be arranged in a release position, in which the securing element is at a distance from the engagement element, and in a securing position, in which the securing element is in engagement with the engagement element. During a movement of the securing element from the release position into the securing position, the securing element can be moved in a first direction, and the engagement element is designed to pass the securing element arranged in the securing position starting from the first damping position. During the passing, the securing element can be moved by the engagement element in a second direction, which is oriented orthogonally to the first direction.

To transfer the damping device from a first damping position into a second damping position, it is necessary to bring the securing element into engagement with the engagement element. For this, in a first step, the securing element is moved in a first direction from a release position into a securing position. In a second step, the securing element can then be passed by the engagement element, wherein during the passing the securing element is moved by the engagement element in a second direction, which is oriented orthogonally to the first direction. Securing element and engagement element are thereby located in a position in which they are in engagement with each other.

It is thereby possible in a simple manner to transfer a damping device from a first damping position into a second damping position.

With respect to fittings which are to be as little visible as possible, during a movement of the securing element from the release position into the securing position, the securing element can be moved in a first direction. The engagement element is designed to pass the securing element arranged in the securing position starting from the first damping position, and during the passing the securing element can be moved by the engagement element in a second direction, which is oriented orthogonally to the first direction.

This also makes it possible in the case of this new type of fitting, to transfer the damping device from a first damping position into a second damping position and thus to adjust the required damping performance.

With respect to a piece of furniture, the piece of furniture comprises a pivoting element, a stationary support and at least one such fitting. The pivoting element is designed in the form of a movable furniture part and the stationary support is designed in the form of a furniture carcass.

The securing device has an actuating element, which can preferably be actuated toollessly, to actuate the securing device.

In particular, if the actuating element can also be actuated toollessly, this represents a simple possibility for a user to transfer a damping device from a first damping position into a second damping position. However, it is also conceivable in principle for the actuating element to be able to be actuated via a tool, such as for example a screwdriver.

In an embodiment of the invention, it can be provided that the actuating element can be actuated by displacing the actuating element, preferably in a direction orthogonal to the first direction and/or orthogonal to the second direction.

This represents a simple actuation method for a user. Moreover, it is also easy to ascertain whether the actuation device has been actuated or not. It is also conceivable for the actuating element to be actuated by another method, for example by turning.

A deflection device can be provided which converts a movement of the actuating element into a movement of the securing element in a first direction.

For this, the deflection device can preferably be designed in the form of a guide groove, and preferably the guide groove is at an angle of between 30° and 55°, preferably an angle of 45°, relative to the first direction.

This represents a simple possibility for implementing a deflection device. Naturally, other forms of a deflection device are also conceivable here. In particular, a deflection device can also be chosen according to the actuation method of the actuating element.

In a closed position of the fitting, the actuating element is covered by the first fitting part or the second fitting part. This contributes to a visually attractive overall impression of the fitting, even in positions other than the closed position.

Preferably, the fitting has a closing device which, at least from a defined position of the two fitting parts relative to each other, automatically transfers the fitting into a closed position of the fitting.

It is thereby ensured that a closing procedure is always carried out or completed correctly and a fitting is also actually closed. Moreover, such a closing device facilitates the use of a piece of furniture or similar with such a fitting.

Preferably, the closing device has an energy store, preferably a spring, particularly preferably a compression spring. Via the energy store, a force which is necessary to transfer the fitting into a closed position can be provided.

In addition, the closing device can have a deflection lever, wherein a deflection roller is arranged on the deflection lever.

Preferably, the energy store is designed to apply a force to the deflection lever. Accordingly, a force provided by the energy store can be deflected via the deflection lever and the deflection roller in order to provide the force at a specified position.

According to an embodiment of the invention, the energy store and the damping device can be arranged substantially parallel to each other in respect of their longitudinal extent.

A space-saving arrangement of the energy store and the damping device is thereby made possible. This favors a small design size of a fitting.

The same also applies if the closing device is arranged in the first fitting part.

The fitting can have at least one first pivot lever and at least one second pivot lever, wherein the two pivot levers are pivotably mounted at a first point on the first fitting part and at a second point on the second fitting part respectively.

For one thing, the two fitting parts are thereby pivotably connected to each other. For another, through the two pivot levers a trajectory is defined along which the second fitting part is pivotable relative to the first fitting part.

Preferably, the first pivot lever has a contact section via which the first pivot lever can be brought into contact with the damping device.

This represents a simple possibility for realizing a damping of a pivoting movement of the two fitting parts relative to each other.

Preferably, the first pivot lever has a control contour along which the deflection roller can travel.

Via the deflection lever, the deflection roller and the control contour, a force made available by the energy store can be applied to the first pivot lever such that a closing device can be easily realized.

Since both the contact section and the control contour are provided on the first pivot lever, only one pivot lever has a somewhat more complicated shape. Overall, however, a fitting thereby becomes less complex, which in turn results in less production effort and lower production costs.

The damping device can be designed in the form of a linear damper. This represents a simple and space-saving possibility for implementing a damping device. However, it is also conceivable for other dampers, such as for example rotary dampers, to be used.

The damping device can have a travel path of between 10 mm and 15 mm, preferably 12 mm. Such a travel path is large enough on the one hand to ensure the best possible damping and small enough on the other not to take up too much space.

In an embodiment of the invention, the damping device can be designed as a spring damper, gas pressure damper, and/or hydraulic damper. Other types of damper are also conceivable.

The damping device can also have a housing.

Particularly preferably, the engagement element is designed in one piece with the housing. Manufacturing steps for manufacturing a separate engagement element and thus also costs can thereby be reduced.

Particularly preferably, the engagement element is designed in the form of a preferably cuboidal projection. This represents the simplest possibility for implementing an engagement element.

It is also conceivable that the engagement element has a beveled area or similar in order to facilitate a passing of the securing element.

Preferably, the securing element can be designed elastic. The securing element, when being passed by the engagement element, can thereby be moved by purely elastic deformation in a second direction which is oriented orthogonally to the first direction.

According to an embodiment of the invention, the securing element can have an area beveled on at least one side, preferably on two sides, in which the securing element can be passed by the engagement element.

This facilitates the passing of the securing element by the engagement element.

With respect to a piece of furniture, the first fitting part is preferably arranged completely in a panel of the support. This favors a visually attractive appearance of the piece of furniture.

The second fitting part can preferably be arranged completely in the pivoting element. This favors a visually attractive appearance of the piece of furniture.

Particularly preferably, at least two fittings are provided. A particularly stable connection of pivoting element and stationary support can thereby be ensured.

### BRIEF DESCRIPTION OF THE DRAWINGS

Further details and advantages of the invention are explained in more detail below with the aid of the description of the drawings, in which:

FIG. 1 is a perspective view of a piece of furniture,

FIG. 2a is a perspective view of a fitting,

FIG. 2b is a perspective view of a fitting in a partly exploded representation,

FIG. 3a is a top view of a fitting in a first damping position,

FIG. 3b is a top view of a damping device in a first damping position,

FIG. 3c shows the detail A of FIG. 3b,

FIG. 4a is a top view of a fitting during a first step during the transfer of the fitting from a first into a second damping position,

FIG. 4b is a top view of a damping device during a first step during the transfer of the fitting from a first into a second damping position,

FIG. 4c shows the detail A of FIG. 4b,

FIG. 5a is a top view of a fitting during a passing of a securing element by an engagement element,

FIG. 5b is a top view of a damping device during a passing of a securing element by an engagement element,

FIG. 5c shows the detail A of FIG. 5b,

FIG. 6a is a top view of a fitting during a second step during the transfer of the fitting from a first into a second damping position,

FIG. 6b is a top view of a damping device during a second step during the transfer of the fitting from a first into a second damping position,

FIG. 6c shows the detail A of FIG. 6b,

FIG. 7a is a top view of a fitting in a second damping position,

FIG. 7b is a top view of a damping device in a second damping position, and

FIG. 7c shows the detail A of FIG. 7b.

### DETAILED DESCRIPTION OF THE INVENTION

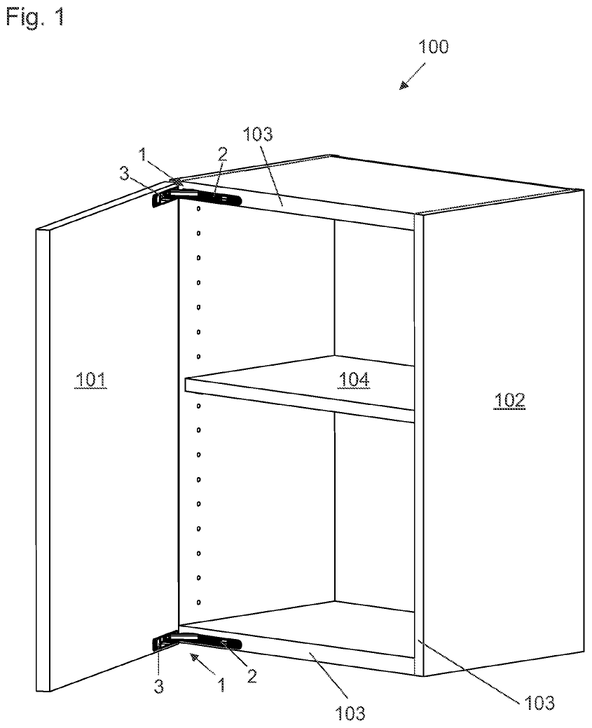

FIG. 1 shows a perspective view of a piece of furniture 100. It can be seen that the piece of furniture 100 has a stationary support 102 in the form of a furniture carcass. The stationary support consists of several panels 103 which are arranged substantially vertical or horizontal.

In this embodiment, two fittings 1 can be seen, wherein the first fitting parts 2 of the fittings 1 are each arranged substantially completely in a horizontally aligned panel 103. The second fitting parts 3 of the fittings 1 are each arranged substantially completely in a pivoting element 101, here in the form of a furniture door.

For example, shelves 104 can be arranged inside the piece of furniture.

It also follows from FIG. 1 that, in the present embodiment, the fittings 1 can scarcely be seen, due to their specific design and arrangement. Substantially only the end faces of the fitting parts 2, 3 can be seen, which results in a visually attractive appearance of the piece of furniture 100.

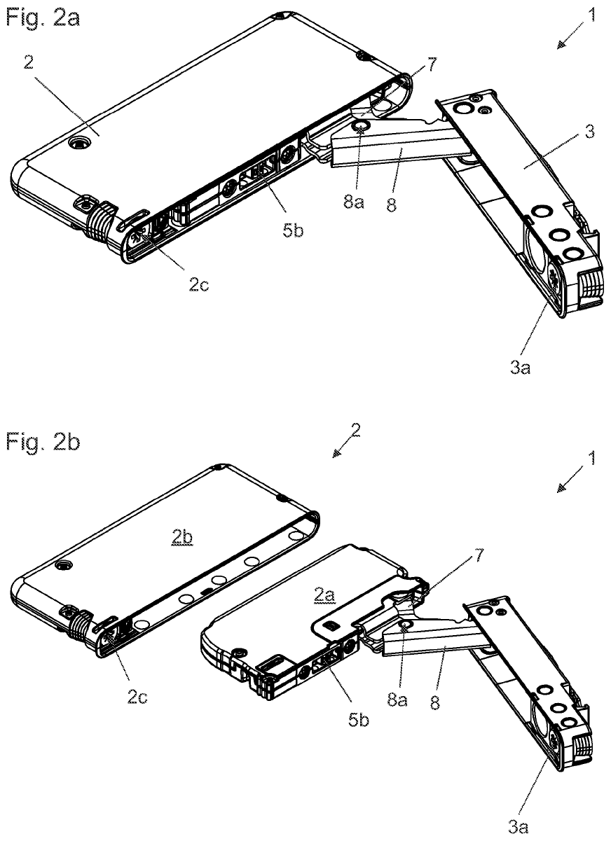

FIG. 2a shows a perspective view of a fitting 1, FIG. 2b shows a corresponding partly exploded representation.

It can be seen that the first fitting part 2 is designed in two parts. An installation part 2b can be inserted into a recess in a panel 103. The installation part 2b can then be fastened in the recess via a fastening device 2c.

In the present embodiment, this is effected by turning an actuating element of the fastening device 2c. This results in a clamping element of the fastening device 2c being turned, as a result of which the installation part 2b is clamped in the recess of the panel 103.

The hinge element 2a can be inserted into the installation element 2b and releasably locked in same.

It can be seen that an actuating element 5b of a securing device 5 is arranged on the end face, which remains visible in an installed state of the fitting 1.

The pivot levers 7 and 8 also lie substantially in a plane with the first fitting part 2. This also applies to the second fitting part 3. However, it also conceivable here that the first fitting part 2 and the second fitting part 3 lie in planes that are turned relative to each other, in particular planes turned by 90° relative to each other.

A fastening device 3a, which functions substantially according to the same principle as the fastening device 2c of the first fitting part 2, is also arranged on the second fitting part 3.

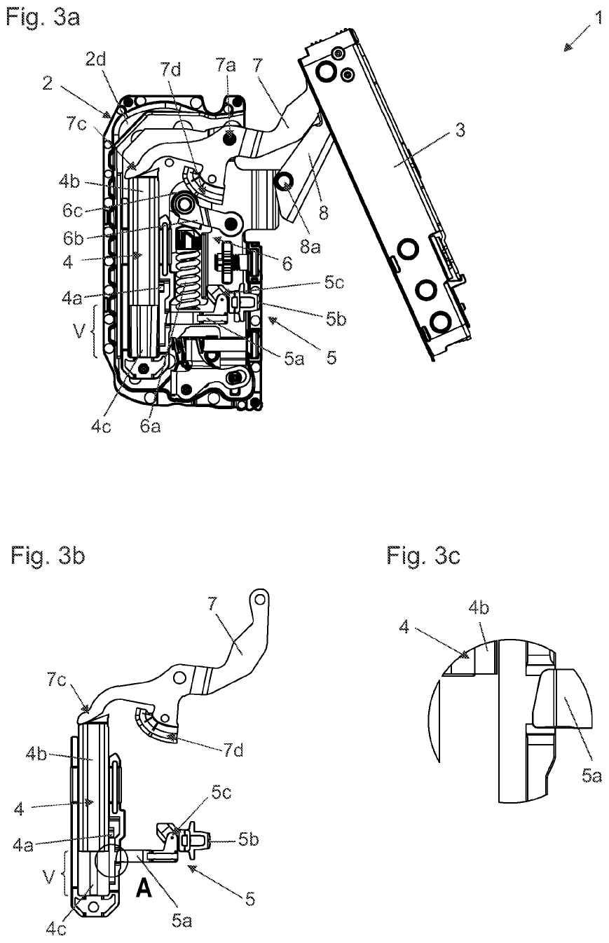

FIG. 3a shows a top view of a fitting 1 in a first damping position, FIG. 3b shows a corresponding top view of a damping device 4 and FIG. 3c shows the detail A of FIG. 3b.

The installation part 9b as well as a cover of the hinge part 2a are not represented in this figure, in order to allow a view into the interior of the hinge part 2a.

A damping device 4 comprises a housing 4b and a piston rod 4c. The piston rod 4c is arranged on a base plate 2d of the first fitting part 2, the housing 4b can move damped along the piston rod 4c.

The damping of a movement of the housing 4b along the piston rod 4c, for example via a spring or a fluid, is effected inside the housing 4b.

The housing 4b can be contacted via a contact section 7c of the first pivot lever 7. The first pivot lever 7 is pivotably connected at a first point 7a to the first fitting part 2 and at a second, not visible, point 7b to the second fitting part 3.

The second pivot lever 8 is also pivotably connected at a first point 8a to the first fitting part 2 and at a second, not visible, point 8b to the second fitting part 3.

Because of the different design of the pivot levers 7, 8, the contact section 7c comes into contact with the housing 4b of the damper 4 from a defined angle of closing between first fitting part 2 and second fitting part 3 (in FIG. 3b, this angle of closing has not yet been reached, and accordingly the contact section 7c is not yet in contact with the housing 4b).

If the fitting 1 is closed further, i.e. the angle of closing is reduced, the contact section 7c moves in the direction of the housing 4b and moves the housing 4b in the direction of the piston rod 4c. This movement is damped by the damping device 4, and accordingly the closing movement is also damped.

In the first damping position, a complete travel path V of the damping element 4 is available for damping.

It can be seen that a securing device 5 is not actuated. Consequently, a securing element 5a has not been moved in a direction into a securing position. The housing 4b can thereby travel unhindered along the whole travel path V along the piston rod 4c.

Moreover, the first pivot lever 7 also has a control contour 7d. The control contour 7d is contacted by a deflection roller 6c of a closing device 6.

The deflection roller 6c is mounted on a deflection lever 6b to which a force is applied from an energy store 6a in the form of a compression spring. The deflection roller 6c is thus pressed against the control contour 7d.

Through a movement of the second fitting part 3, the control contour 7c travels along the roller 6c. From a specific angle of closing of the fitting 1, the roller 6c is located in a section of the control contour 7d in which the force exerted on the control contour 7d through the deflection roller 6c results in the deflection lever 7 being pivoted. This has the result that, through this pivoting movement, the deflection lever 7 moves the second fitting part 3 in the direction of a closed position of the fitting 1.

It can also be seen that an engagement element 4a in the form of a projection is formed on the housing 4b.

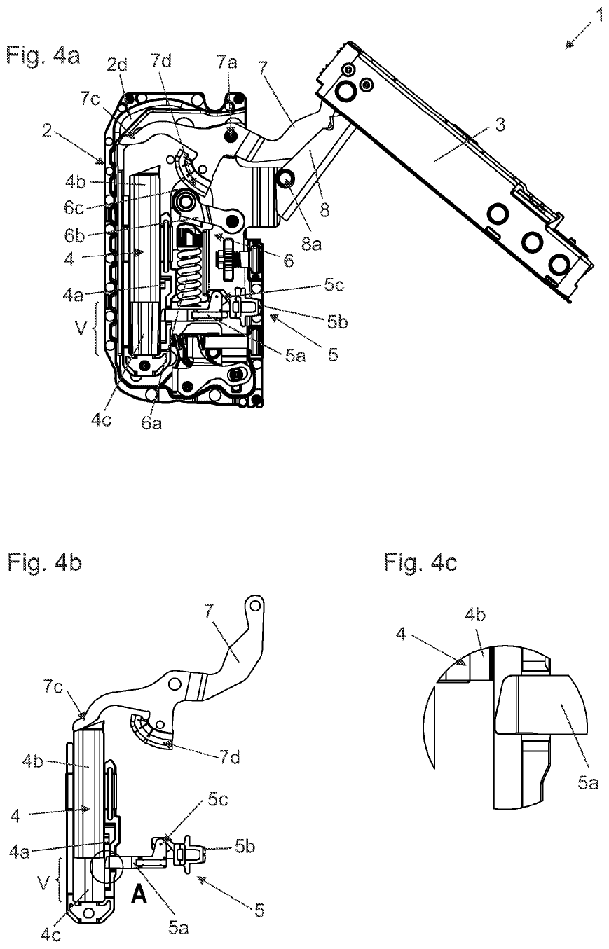

FIG. 4a shows a top view of a fitting 1 during a first step during the transfer of the fitting 1 from a first into a second damping position, FIG. 4b shows a corresponding top view of a damping device 4 and FIG. 4c shows the detail A of FIG. 4b.

It can be seen that the actuating element 5b of the securing device 5 is actuated. Through the actuation of the actuating element, the securing element 5a is moved in a first direction and thus transferred into a securing position.

The conversion of the movement of the actuating element 5b into a movement of the securing element 5a is effected via a deflection device 5c. In the present embodiment, the deflection device comprises a guide groove in which the securing element 5c is displaceably mounted.

The guide groove is arranged at an angle of 45° to a movement direction of the actuating element 5b. The securing element 5a is movable only in a first direction, which is parallel to a longitudinal extent of the securing element 5a. A movement of the actuating element 5b thus results in a movement of the securing element 5a in the first direction.

In this step, the securing element 5a has been moved in the direction of the damping device.

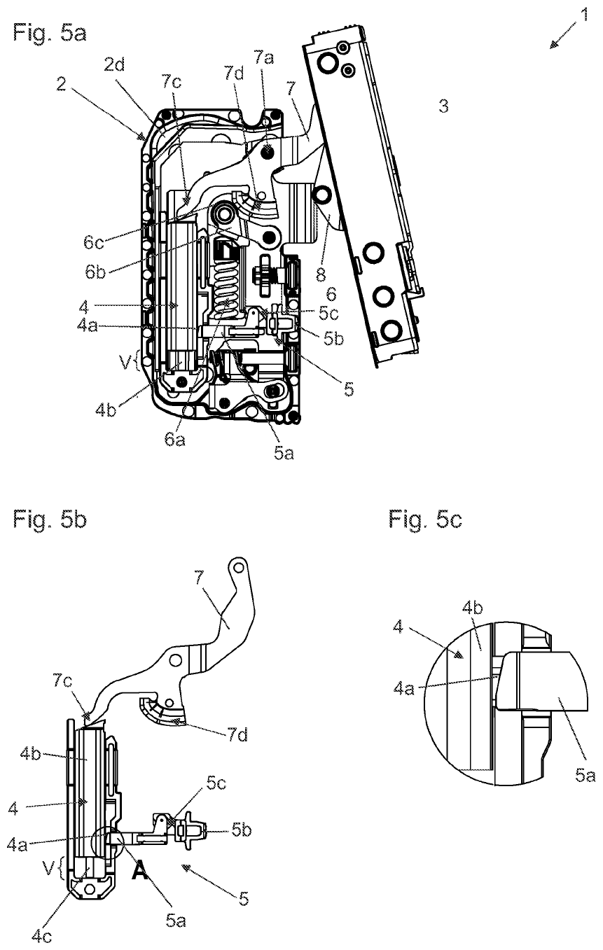

FIG. 5a shows a top view of a fitting during a passing of a securing element 5a by an engagement element 4a, FIG. 5b shows a corresponding top view of a damping device 4 and FIG. 5c shows the detail A of FIG. 5b.

It can be seen that the housing 4b has been moved in the direction of the piston rod 4c, as a result of which the engagement element 4a has also been moved in the direction of the securing element 5a.

During the passing of the securing element 5a, the engagement element 4a moves the securing element 5a in a second direction, upwards in the present case. In this embodiment, the second direction is thus oriented both orthogonally to a first direction (which is parallel to the longitudinal extent of the securing element) and orthogonally to an actuating direction of the actuating element 5b.

The securing element 5a can be beveled in an area in which it can be passed by the engagement element 4a, in order to facilitate a corresponding passing. The engagement element 4a can also be beveled, at least in areas, in order to facilitate a passing.

Moreover, the securing element 5a is designed elastic, at least in areas, in order to implement a passing by the engagement element 4a easily.

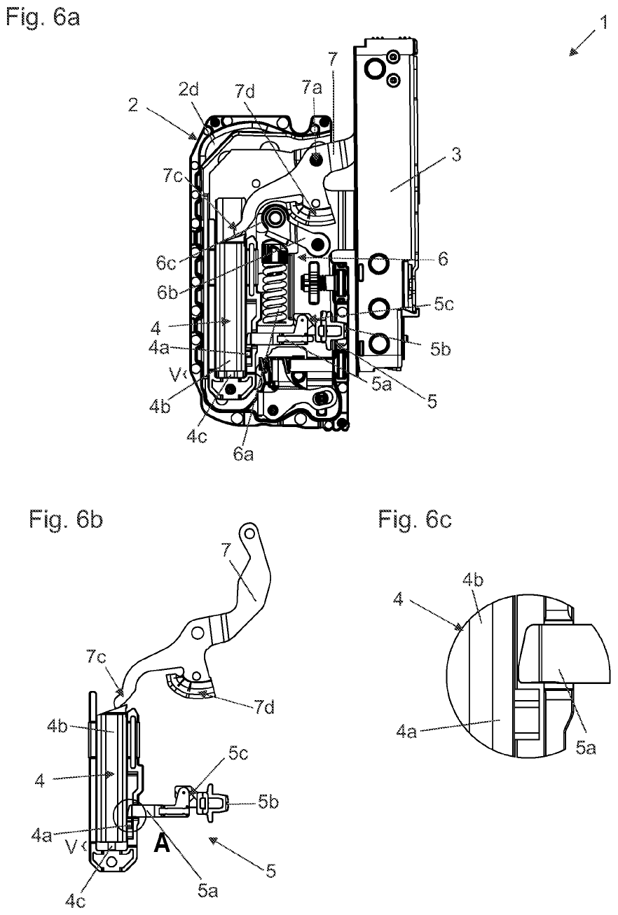

FIG. 6a shows a top view of a fitting 1 during a second step during the transfer of the fitting 1 from a first into a second damping position, FIG. 6b shows a corresponding top view of a damping device 4 and FIG. 6c shows the detail A of FIG. 6b.

It can be seen that the securing element 5a has been completely passed by the engagement element 4a. The housing 4b has been moved most of the way along the travel path V along the piston rods 4c.

It can also be seen that the engagement element 4a is not yet in engagement with the securing element 5a.

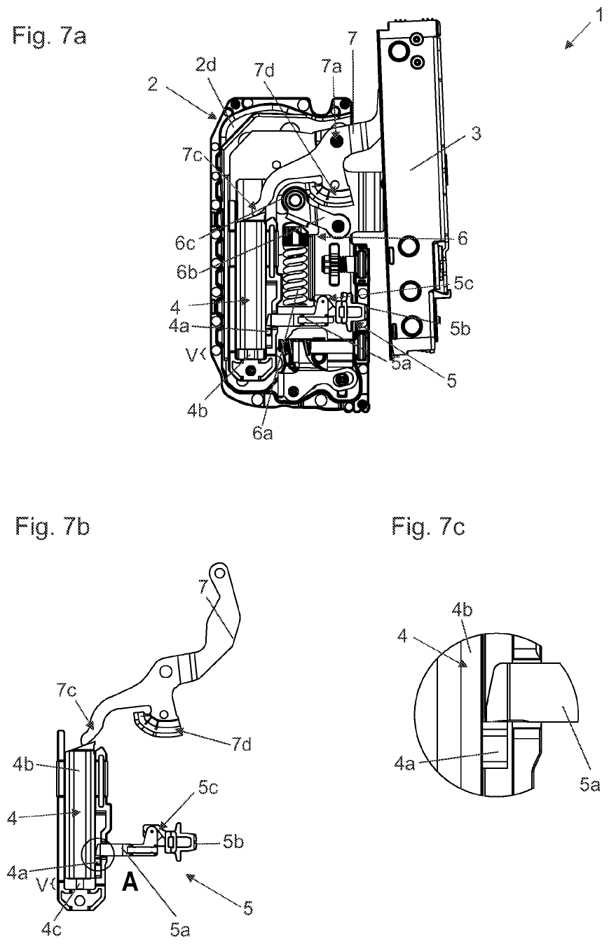

FIG. 7a shows a top view of a fitting 1 during a second step during the transfer of the fitting 1 from a second damping position, FIG. 7b shows a corresponding top view of a damping device 4 and FIG. 7c shows the detail A of FIG. 7b.

It can be seen that the engagement element 4a is now in engagement with the securing element 5a. The housing 4b is thus greatly restricted in its travel path V. A damping of a closing movement of the fitting 1 can thus now only be effected on the restricted travel path V. The damping performance is thus reduced relative to the first damping position.

In order to transfer the damping device 4 back into the first damping position, it is merely necessary to actuate the actuating element 5b. The securing element is thereby moved back into a release position. The engagement element 4a is then no longer in engagement with the securing element 5a, as a result of which the complete travel path V is again available to the damping device 4.

### LIST OF REFERENCE NUMBERS

1 fitting
2 first fitting part
2a hinge element
2b installation part
2c fastening device
2d base plate
3 second fitting part
3a fastening device
4 damping device
4a engagement element
4b housing
4c piston rod
5 securing device
5a securing element
5b actuating element
5c deflection device
6 closing device
6a energy store
6b deflection lever
6c deflection roller
7 first pivot lever
7a first point
7b second point
7c contact section
7d control contour
8 second pivot lever
8a first point
8b second point
100 piece of furniture
101 pivoting element
102 stationary support
103 panel
104 shelf
V travel path

1. A fitting for movably mounting a pivoting element, in particular a furniture part, a door or a window, relative to a stationary support comprising:
a first substantially cuboidal fitting part, which can be arranged substantially completely in a recess in an end face of a preferably substantially horizontally or vertically aligned panel of the support,
a second fitting part for fastening on the pivoting element, wherein the second fitting part is connected pivotably to the first fitting part, wherein the second fitting part can be arranged substantially completely in the pivoting element, and
a damping device for damping a pivoting movement, preferably a closing movement, of the two fitting parts relative to each other,
wherein the damping device can be transferred from a first damping position into a second damping position with a reduced damping performance relative to the first damping position, wherein the damping device is arranged in the first fitting part, and that a securing device is provided for holding the damping device in the second damping position.

2. The fitting according to claim 1, wherein the damping device has an engagement element and the securing device has a securing element, wherein the securing element can be arranged in a release position, in which the securing element is at a distance from the engagement element, and in a securing position, in which the securing element is in engagement with the engagement element, wherein during a movement of the securing element from the release position into the securing position the securing element can be moved in a first direction, and that the engagement element is designed to pass the securing element arranged in the securing position starting from the first damping position, wherein during the passing the securing element can be moved by the engagement element in a second direction, which is oriented orthogonally to the first direction.

3. The fitting according to claim 1, wherein the securing device has an actuating element, which can preferably be actuated toollessly, to actuate the securing device.

4. The fitting according to claim 3, wherein the actuating element can be actuated by displacing the actuating element, preferably in a direction orthogonal to the first direction and/or orthogonal to the second direction.

5. The fitting according to claim 2, wherein a deflection device is provided which converts a movement of the actuating element into a movement of the securing element in the first direction.

6. The fitting according to claim 5, wherein the deflection device is designed in the form of a guide groove, preferably wherein the guide groove is at an angle of between 30° and 55°, preferably an angle of 45°, relative to the first direction.

7. The fitting according to claim 3, wherein, in a closed position of the fitting, the actuating element is covered by the first fitting part or the second fitting part.

8. The fitting according to claim 1, wherein the fitting has a closing device which, at least from a defined position of the two fitting parts relative to each other, automatically transfers the fitting into a closed position of the fitting.

9. The fitting according to claim 8, wherein the closing device has an energy store, preferably a spring, particularly preferably a compression spring.

10. The fitting according to claim 8, wherein the closing device has a deflection lever, wherein a deflection roller is arranged on the deflection lever.

11. The fitting according to claim 9, wherein the energy store is designed to apply a force to the deflection lever.

12. The fitting according to claim 9, wherein the energy store and the damping device are arranged substantially parallel to each other in respect of their longitudinal extent.

13. The fitting according to claim 8, wherein the closing device is arranged in the first fitting part.

14. The fitting according to claim 1, wherein the fitting has at least one first pivot lever and at least one second pivot lever, wherein the two pivot levers are pivotably mounted at a first point on the first fitting part and at a second point on the second fitting part respectively.

15. The fitting according to claim 14, wherein the first pivot lever has a contact section via which the first pivot lever can be brought into contact with the damping device.

16. The fitting according to claim 10, wherein the first pivot lever has a control contour along which the deflection roller can travel.

17. The fitting according to claim 1, wherein the damping device is designed in the form of a linear damper.

18. The fitting according to claim 17, wherein the damping device has a travel path of between 10 mm and 15 mm, preferably 12 mm.

19. The fitting according to claim 1, wherein the damping device is designed as a spring damper, gas pressure damper and/or hydraulic damper.

20. The fitting according to claim 1, wherein the damping device has a housing.

21. The fitting according to claim 20, wherein the engagement element is designed in one piece with the housing.

22. The fitting according to claim 2, wherein the engagement element is designed in the form of a preferably cuboidal projection.

23. The fitting according to claim 1, wherein the securing element is designed elastic, at least in areas.

24. The fitting according to claim 1, wherein the securing element has an area that is beveled at least on one side, preferably on two sides, in which the securing element can be passed by the engagement element.

25. A piece of furniture, comprising a pivoting element, a stationary support and the fitting according to claim 1, wherein the pivoting element is designed in the form of a movable furniture part and the stationary support is designed in the form of a furniture carcass.

26. The piece of furniture according to claim 25, wherein the first fitting part is preferably arranged completely in a panel of the support.

27. The piece of furniture according to claim 25, wherein the second fitting part is preferably arranged completely in the pivoting element.

28. A piece of furniture according to claim 25, wherein at least two fittings are provided.
